(19) United States
(12) Patent Application Publication
(10) Pub. No.: US 2016/0124397 A1
(43) Pub. Date: May 5, 2016

(54) HANDHELD UNIT WITH COMBINED SIGNAL EVALUATION

(71) Applicant: SIEMENS AKTIENGESELLSCHAFT, München (DE)

(72) Inventors: JOCHEN BRETSCHNEIDER, Esslingen (DE); OLE DRAEGER, MOEHRENDORF (DE); WERNER EBERLEIN, ERLANGEN (DE)

(73) Assignee: SIEMENS AKTIENGESELLSCHAFT, 80333 München (DE)

(21) Appl. No.: 14/897,153

(22) PCT Filed: Aug. 27, 2013
(86) PCT No.: PCT/EP2013/067664

§ 371 Date: Dec. 9, 2015

(30) Foreign Application Priority Data
Jun. 10, 2013 (EP) 13171199.6

(51) Int. Cl. G05B 9/02

(52) U.S. Cl. CPC G05B 9/02

(57) ABSTRACT

A handheld unit for an industrial technical system comprising some of the following: a proximity sensor, an acceleration sensor, an orientation sensor, a position-determining device and an image-capturing device. Commands input by a user to the handheld unit and output signals from the modules are fed to an evaluation device in the handheld unit that transmits control commands to a control device in the industrial technical system. The evaluation device compares output signals of the modules to predetermined first signal patterns and transmits commands that activate components in the industrial technical system to the control device only if the command requested and the output signals of the modules match one of the predetermined first signal patterns. Otherwise the evaluation device does not transmit the control commands.

The present invention relates to a method of operation for a handheld unit for an industrial technical system,
wherein the handheld unit comprises an input device,
wherein the handheld unit comprises a number of the modules proximity sensor, acceleration sensor, orientation sensor, position-determining device and image-capturing device,
wherein commands entered by a user of the handheld unit via an input device and output signals of the modules are fed to an evaluation device of the handheld unit,
wherein the evaluation device evaluates the commands and the output signals and, as a function of evaluation, transmits control commands to a control device of the industrial technical system.

The present invention further relates to a handheld unit for an industrial technical system,
wherein the handheld unit comprises an input device,
wherein the handheld unit comprises a number of the modules proximity sensor, acceleration sensor, orientation sensor, position-determining device and image-capturing device,
wherein the handheld unit comprises an evaluation device, to which commands input by a user of the handheld unit via the input device and output signals of the modules are fed,
wherein the evaluation device is embodied such that it evaluates the commands and the output signals and, as a function of the evaluation, transmits control commands to a control device of the industrial technical system.

Such methods of operation and such handheld units are generally known.

For commissioning, calibration and optimization of processing in industrial technical systems—for example machines—the user often has to work with reduced safety. For example the user must move within a danger area of the technical system (machine) or protective doors are opened and further similar situations occur. Examples of these types of operating situations are operations to set up a machine with a protective door open, driven movement of axes while the user is located within the danger area (movement area) of the axes, operation of a crane while standing under the load, calibration of a press with opened press tools and further similar situations.

In these types of operating situations the safety of the user is at the forefront of automation technology measures. In particular actions of the user must be safeguarded by suitable measures on the automation side. In the prior art this is done by safe design of communication between the user and the control device of the industrial technical system and by a user explicitly agreeing to hazardous actions. For example the safety-relevant signals such as emergency shutdown and the like are requested via two channels and to actually initiate a hazardous action, in addition to the actual specification of the action, the actuation of a separate confirmation key by the user is necessary.

To control the industrial technical system as part of commissioning, calibration and optimization, mobile handheld units are often used, so that the user can operate the technical system although they themselves are in the danger area. Such instruments are usually expensive special products, which offer relatively little flexibility. The alternatives for communication between the handheld unit and the control device are either wired or wireless.

The object of the present invention is to create opportunities by means of which, in a simple and reliable manner, safety can be enhanced while recognizing that the user has actually requested the activation of a component of the industrial technical system.

The object is achieved by a method of operation with the features of claim 1. Advantageous embodiments of the method of operation are the subject matter of dependent claims 2 to 6.

In accordance with the invention a method of operation of the type described at the outset is embodied in that,
the evaluation device, as part of the evaluation, compares the output signals of the modules to predetermined first signal patterns and
the evaluation device transmits control commands, which effect an activation of components of the industrial technical system, to the control device when a user specifies a command requesting the activation of the components and the output signals of the modules match one of the first predetermined signal patterns, and otherwise does not transmit the control commands.

For example it is possible, as part of the evaluations, initially to evaluate the output signals of each of the modules individually in each case and to determine a vote for each evaluated module in each case and then to establish a resulting evaluation on the basis of the votes.

To establish the respective vote it is possible to proceed as follows for example:
The output signal of the proximity sensor is evaluated by the evaluation device to establish whether an object is located sufficiently close to the proximity sensor. If it is, it can be assumed that an agreement of the user to an action can exist (positive vote). if not, there is a negative vote.
The output signal of the acceleration sensor is evaluated by the evaluation device to establish whether the acceleration values lie below acceleration limit values and/or vibrations do not exceed a predetermined first level. If they do, it can be assumed that an agreement of an operator to an action can exist (positive vote). If not, there is a negative vote.
The output signal of the orientation sensor is evaluated by the evaluation device to establish whether the handheld unit is oriented such that its operator surface is pointing upwards. If it is, it can be assumed that an agreement of an operator to an action can exist (positive vote). If not, there is a negative vote.
The output signal of the position-determining device is evaluated by the evaluation device to establish the point in the room at which the handheld unit is located. Only when the position of the handheld unit lies outside predetermined protection zones can it be assumed that an agreement of an operator to an action can be present (positive vote). If not, there is a negative vote.
The image-capturing device can capture an image for example which—provided there is normal operation—shows the user. The output signal of the image-capturing device can be evaluated by the evaluation device to establish whether the captured image actually shows the user. If it does, it can be assumed that an agreement of an operator to an action can be present (positive vote). If not, there is a negative vote.

As a resulting evaluation for example an activation of a component of the industrial technical system can be allowed (=agreement), if all evaluated output signals deliver a positive vote. In this case the (single) predetermined first signal pattern corresponds to the positive vote of all evaluated output signals. As an alternative it is possible to allow a predetermined number of negative votes. In this case the predetermined first signal patterns correspond to the possible combinations of votes, which include the required number of positive votes (or even more positive votes).

It is possible to evaluate all output signals. As an alternative it is possible to use only a part of the output signals as part of the evaluation explained above. Furthermore it is possible to combine output signals with one another.

It is also necessary, as part of the control of the industrial technical system, to reliably recognize an emergency shutdown request. Preferably there is therefore provision for the evaluation device, as part of the evaluation, to compare the output signals of the modules with predetermined second signal patterns and to transmit an emergency shutdown request to the control device if the output signals of the modules match one of the predetermined second signal patterns.

As regards the approach, the output signals of the modules can be evaluated in respect of the agreement in a two-stage process, in a similar way to the output signals of the modules. In particular the following evaluations are possible for example:
The output signal of the proximity sensor is evaluated by the evaluation device to establish whether an object is at a sufficient distance from the proximity sensor. If it is not, an emergency shutdown is triggered. This procedure can differ from the procedure for establishing whether an agreement is present for example, in that a different sensitivity is selected. As an alternative or in addition a number of proximity sensors can be disposed at different points on the handheld unit and agreement, non-agreement and emergency shutdown are differentiated by the number of proximity sensors which detect an object in sufficient proximity.
The output signal of the acceleration sensor is evaluated by the evaluation device to establish whether the acceleration values lie below acceleration limit values and/or vibrations exceed a predetermined second amount. If this is the case it can be assumed that the handheld unit has fallen on the floor. In this case an emergency shutdown request is triggered.
The output signal of the orientation sensor is evaluated by the evaluation device as to whether the handheld unit is oriented such that its operating surface is pointing downwards or sideways. If this is the case an emergency shutdown request can be triggered. Under some circumstances this evaluation can be combined with other evaluations, especially of the output signal of the acceleration sensor. For example an emergency shutdown request can be triggered if, after a value drops below predetermined acceleration limit values, which as such would not directly trigger an emergency shutdown request, an orientation of the operator surface of the handheld unit downwards or to the side is detected.
The output signal of the position-determining device is evaluated by the evaluation device as to the position in the room at which the handheld unit is located. If the position of the manual operating device lies within predetermined forbidden zones, an emergency shutdown request can be triggered.

In an especially preferred embodiment of the method of operation the handheld unit additionally comprises a magnetic field sensor and/or a microphone. In this case it is possible for the evaluation device, when comparing the output signals of the modules to the predetermined second signal patterns, to take account of the magnetic field sensor and/or of the microphone. The following evaluations are possible for example:
The output signal of the magnetic field sensor is evaluated by the evaluation device to establish whether a predetermined limit magnetic field is exceeded. If this is the case, an emergency shutdown request can be triggered. This procedure can require an interaction with magnets, which are disposed at predefined locations of the industrial technical system.
The output signal of the microphone is evaluated by the evaluation device to establish whether a predetermined volume is exceeded (cry of panic). If this is the case, an emergency shutdown request can be triggered.

An emergency shutdown request is preferably triggered for safety reasons as soon as the evaluation of a single output signal indicates an emergency shutdown request.

Preferably there is provision to transmit an alive signal to the control device at cyclic intervals. The result achieved by this can be that the control device carries out an emergency shutdown or a similar safety-oriented measure in the absence of the alive signal.

Preferably there is further provision for the handheld unit additionally to include a brightness sensor and for the evaluation device, as part of the comparison of the output signals of the modules to the predetermined first signal patterns, to take account of an output signal of the brightness sensor. For example an agreement can be declined if a value falls below a predetermined first minimum brightness.

In the event of a brightness sensor being present—as an alternative or in addition to the evaluation as part of the comparison of the output signals of the modules with the predetermined first signal patterns—an emergency shutdown request can be triggered of a value falls below a predetermined second minimum brightness.

In the event of the presence of an acceleration sensor, the evaluation of the output signal of the acceleration sensor preferably includes a comparison with vibrations and/or acceleration limit values.

The object is further achieved by a handheld unit with the features of claim 7. Advantageous embodiments of the handheld unit are the subject matter of dependent claims 8 to 13.

In accordance with the invention, a handheld unit of the type described above is designed such that,
the evaluation device is embodied such that, as part of the evaluation, it compares the output signals of the modules to predetermined first signal patterns, transmits control commands, which effect an activation of components of the industrial technical system, to the control device, when the user specifies a command requesting the activation of the components and the output signals of the modules match one of the predetermined first signal patterns, and otherwise does not transmit the control commands.

The advantageous embodiments of the handheld unit essentially correspond to those of the operating method. Furthermore it is possible for the operating instrument to be embodied as a communication technology device.

The characteristics, features and advantages of this invention described above, as well as the manner in which these are achieved, will become clearer and easier to understand in conjunction with the following description of the exemplary embodiments, which are explained in greater detail in conjunction with the drawings. In the drawings, in schematic diagrams:

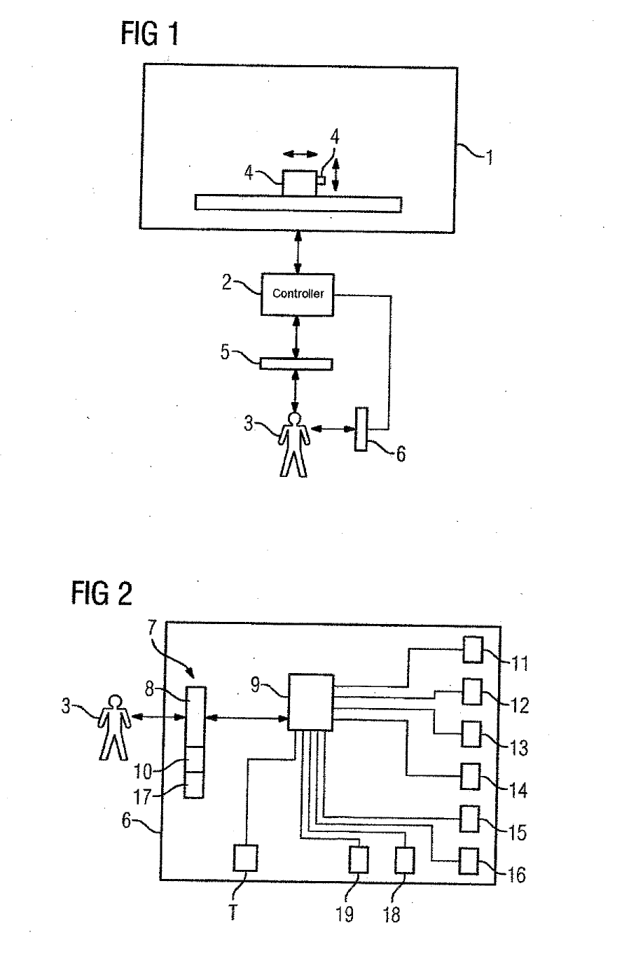

FIG. 1 shows an industrial technical system,

FIG. 2 shows an operating instrument, and

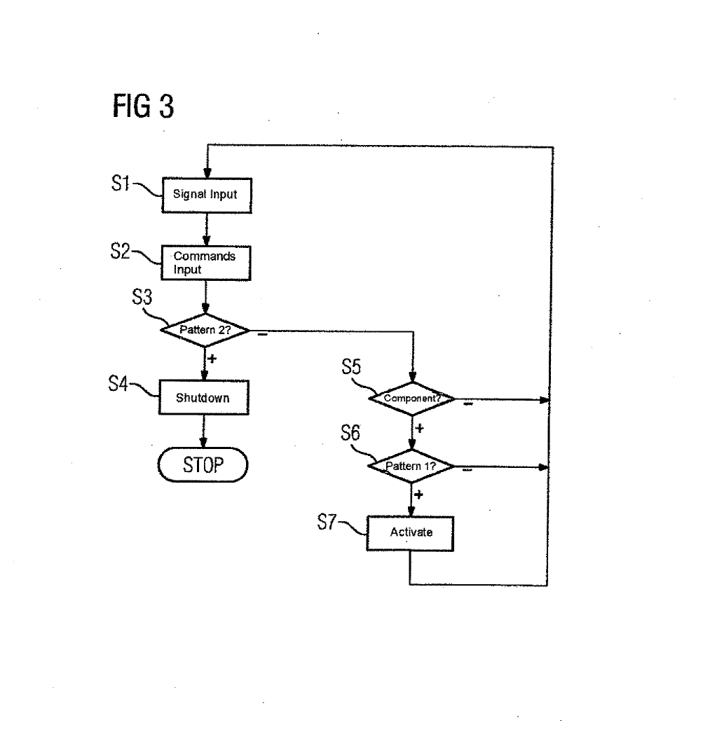

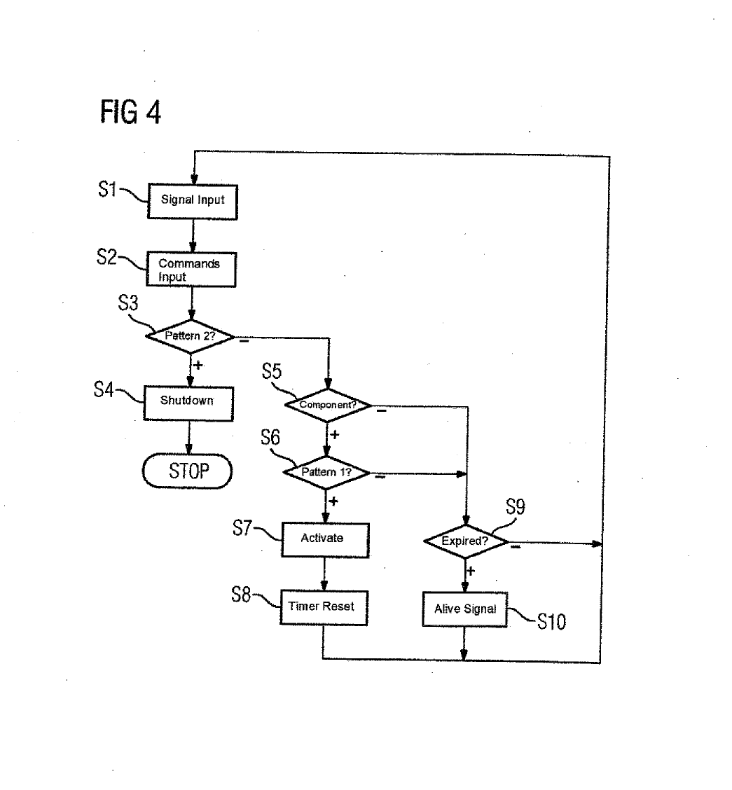

FIGS. 3 and 4 show flow diagrams.

In accordance with FIG. 1, an industrial technical system 1 is controlled by a control device 2. The industrial technical system can in principle be of any nature. For example it can involve a machine tool or another production machine. It can also involve a packaging machine, a filling system, a crane or another industrial technical system. The control device 2 can principally likewise be of any nature. It often involves a numerical controller, a programmable logic controller or a combination of a numerical controller and a programmable logic controller.

Commands can be specified by a user 3 to the control device 2. As a result of the commands specified by the user 3—depending on the specified command—components 4 of the industrial technical system 1 can be activated. In particular for example the components 4 can often be driven, i.e. moved.

To specify the commands the user 3 generally has a control panel 5 available to them. The control panel 5, where present, is disposed at a fixed location outside the action area of the industrial technical system 1. In normal operation of the industrial technical system 1 the commands are specified via the control panel 5. The user 3, when specifying the commands via the control panel 5, must therefore necessarily be located outside the action area. In specific operating modes of the industrial technical system 1 this is not possible however. Examples of these types of specific operating modes are a calibration mode with the protective door open, driving of axes while the user 3 is located in the danger area (=drive area or action area) of the axes, the operation of a crane when standing beneath the load, the calibration of a press with open press tools and more such situations. In this case it must likewise be possible to activate the corresponding component 4. For this purpose the user 3 is provided with a handheld unit 6. The handheld unit 6 is a mobile device which can communicate with the control device 2 via a connecting line or wirelessly. It can be embodied in principle in any given way. Preferably the handheld unit 6 is embodied as a communication technology device, as a smartphone, as an iPod or as an iPad for example.

Secure communication between the handheld unit 6 and the control device 2 is known as such. It can especially comprise the use of (at least) two communication channels with different characteristics, which the handheld unit 6 has. Especially when the device is embodied as a smartphone, two of the channels Bluetooth, WLAN, GRPS, UMTS and other similar channels can be used.

When components 4 of the industrial technical system 1 are to be activated while the user 3 is located in the danger area of the industrial technical system 1, it must be guaranteed that an activation of a specific component 4 is actually desired by the user 3. For this purpose the handheld unit 6 in accordance with FIG. 2 has an input device 7. The input device 7 includes units such as a specification device 8, by means of which the user 3 can specify a corresponding command to the handheld unit 6. The specification device 8 can be embodied for example as a normal keyboard or as a touchscreen.

The handheld unit 6 also has an evaluation device 9. The evaluation device 9 is supplied with commands, which are entered by the user 3 via the specification device 8 into the handheld unit 6. The evaluation device 9 only transmits the corresponding control command to the control device 2 however when the evaluation device 9 has established that the user 3 has explicitly agreed to the activation of the respective component 4. Otherwise the evaluation device 9 blocks the transmission of the corresponding activation signal.

Preferably, in addition to the specification device 8, the input device 7 includes a self-contained, additional confirmation device 10. The confirmation device 10 can be embodied as a key for example. If the confirmation device 10 is present, it is necessary for the agreement by the user 3 that the user 3 actuates the confirmation device 10 when specifying the corresponding command or within a brief time window before or afterwards (for example within between 2 and 5 seconds). This procedure is known as such in the prior art and can also be realized as part of the present invention. Regardless of whether or not this realization is implemented, further measures are taken in accordance with the invention however, which are explained in greater detail below.

In accordance with FIG. 2, the handheld unit 6 has a number of modules 11 to 15. The individual modules involved can depend on the concrete embodiment of the handheld unit 6. At least a number of the following modules 11 to 15 are present however:
A proximity sensor 11, by means of which it is detected whether an object (for example a hand of the user 3) is located in the vicinity of the corresponding proximity sensor 11. The term “in the vicinity of” in this context means at a distance in centimeters in single figures or below from the corresponding proximity sensor 11. If necessary a number of proximity sensors 11 can be present.
An acceleration sensor 12, by means of which the accelerations to which the handheld unit 6 is subject are detected. The evaluation of the output signal of the acceleration sensor 12 can especially include a comparison to vibrations and/or acceleration limit values.
An orientation sensor 13, by means of which an orientation of the manual operating device 6, at least relative to a vertical direction, can be established.
A position-determining device 14, by means of which a position of the handheld unit 6 in the three-dimensional space can be detected.
An image-capturing device 15, by means of which, starting from the input device 7, an image is captured, which under normal circumstances includes at least the head, mostly also the torso, of the user 3.

Output signals of the said modules 11 to 15 are likewise fed to the evaluation device 9. The evaluation device 9 evaluates the output signals transmitted to it. In particular the evaluation device 9 compares the output signals to pre-determined first signal patterns. If the result of the comparison is that the output signals match one of the pre-determined first signal patterns, the evaluation device 9 evaluates these matches as an agreement of the user 3 to an activation of a component 4 of the industrial technical system 1.

The evaluation device 9 thus first checks whether the user 3 has requested an activation of a component 4 of the industrial technical system 1 via the input device 7 (if necessary including the agreement via the confirmation device 10). This check is (still) made exclusively while evaluating the inputs, which the user 3 has made via the input device 7.

If the result of this check is that the user 3 has not requested an activation of a component 4 of the industrial technical system 1, no corresponding control command (naturally) has to be transmitted to the control device 2. If however the result of this check is that the user 3 has requested an activation of a component 4 of the industrial technical system 1, the evaluation device 9 additionally checks whether an agreement of the user 3 is present. This check is made by utilizing the output signals of the modules 11 to 15. Only if this check has resulted in an agreement of the user 3 does the evaluation device 9 transmit the corresponding control command to the control device 2. If not, i.e. if
either the user 3 has not requested any activation at all, or
the user 3 has actually requested an activation, but has not actuated the confirmation device 10 and/or the evaluation of the output signals does not produce any agreement.

The evaluation device 9 does not transmit the corresponding control command to the control device 2.

It is possible for the handheld unit 6, in addition to the said modules 11 to 15, to comprise a brightness sensor 16 as a further module 16. In this case the evaluation of the output signals of the modules 11 to 16 can also include the output signal of the brightness sensor 16. Thus, in this case the evaluation device 9, as part of the comparison of the output signals of the modules 11 to 16 with the predetermined first signal patterns, additionally takes account of the output signal of the brightness sensor 16.

As part of the operation of the industrial technical system 1 it can occur that the user 3 wishes to carry out an emergency shutdown. This option is also possible via the handheld unit 6. For example the handheld unit 6 can have a specific emergency shutdown key 17, which when activated, causes the evaluation device 9 to transmit an emergency shutdown request to the control device 2. In addition it is possible however for the evaluation device 9, as part of the evaluation, not only to compare the output signals of the modules 11 to 15 (or 11 to 16) with the predetermined first signal patterns, but also with the predetermined second signal patterns. The second signal patterns are different signal patterns from the first signal patterns. If the result of the evaluation is that the output signals of the modules 11 to 15 (or 11 to 16) match a predetermined second signal pattern, the evaluation device 9 transmits an emergency shutdown request immediately and as a matter of priority to the control device 2.

It is possible for the handheld unit 6, in addition to the aforementioned modules 11 to 15 or 11 to 16, to have a magnetic field sensor and or a microphone as further modules 18 and 19. In this case the evaluation of the output signals of the modules 11 to 15 (16), at least regarding the comparison with the second signal patterns, can also include the output signals of the magnetic field sensor 18 and/or of the microphone 19. The evaluation device 9 thus also takes into account in this case, as part of the comparison of the output signals of the modules 11 to 16 with the predetermined second signal patterns, the output signals of the magnetic field sensor 18 and/or the microphone 19.

FIG. 3 shows the procedure explained above once again, in the form of a flow diagram.

In accordance with FIG. 3 the evaluation device 9, in a step S1, accepts their output signals from the modules 11 to 19. In a step S2, the evaluation device 9 accepts from the input device 7 the commands, which the user 3 has entered via the input device 7.

In a step S3 the evaluation device 9 performs an evaluation (check) of the output signals of the modules 11 to 19 in relation to the second signal pattern. Provided a match is produced here, the evaluation device 9 proceeds to a step S4, in which it transmits an emergency shutdown request to the control device. Otherwise the evaluation device 9 proceeds to a step S5.

In step S5 the evaluation device 9 performs an evaluation (check) of the commands, which the user 3 has entered via the input device 7. If the result of this check is that the user 3 has requested an activation of a component 4 of the industrial technical system 1, the evaluation device 9 proceeds to a step S6. Otherwise the evaluation device 9 returns to the step S1.

In step S6 the evaluation device 9 performs an evaluation (check) of the output signals of the modules 11 to 19 as regards the first signal pattern. Provided a match is produced here, the evaluation device 9 proceeds to a step S7. Otherwise the evaluation device 9 returns to the step S1.

In step S7 the evaluation device 9 transmits the control command, with which the user 3 has requested an activation of the component 4, to the control device 2. Then the evaluation device 9 returns to step S1.

The procedure of FIG. 3 can be modified in accordance with the diagram shown in FIG. 4. In accordance with FIG. 4 steps S8 to S10 are present in addition to steps S1 to S7.

Step S8 follows on from step S7. In step S8 the evaluation device 9 resets a timer 20. The timer 20 is programmed with a predetermined time.

Step S9 is processed in the No branch of steps S5 and S6. In step S9 the evaluation device 9 checks whether the timer 20 has expired. If this is not the case, the evaluation device 9 returns directly to step S1. Otherwise the evaluation device 9 first executes step S10 and only then returns to step S1. In step S10 the evaluation device 9 transmits an alive signal to the control device 2. The alive signal is evaluated by the control device 2. If the signal does not arrive, the control device 2 automatically carries out a safety action. For example it can shut down the industrial technical system 1.

The present invention has many advantages. In particular, despite the use of a communication technology device as handheld unit 6, the functional safety can be markedly enhanced by redundant interrogation of a number of modules 11 to 19, although the operating elements of communication technology devices are far from having the same robustness and longevity as the actuation elements of handheld units specifically developed for this purpose.

Although the invention has been illustrated and described in greater detail by the preferred exemplary embodiments, the invention is not restricted by the disclosed examples and other variations can be derived herefrom by the person skilled in the art, without departing from the scope of protection of the invention.

1.-13. (canceled)

14. A method of operating a handheld unit for an industrial technical system having a control device and a handheld unit including a user input device, a plurality of physical and image sensor modules, comprising:
entering user commands into the handheld unit;
feeding signals output by the modules to an evaluation device of the handheld unit;
evaluating the commands and the output signals, including comparing the output signals of the modules to predetermined first signal patterns; and
transmitting control commands that effect an activation of the components of the industrial technical system entered into the control device by a user of the industrial technical system to the control device, only if the output signals of the modules match a predetermined first signal pattern.

15. The method of claim 1, further comprising comparing the output signals of the modules to predetermined second signal patterns; and transmitting an emergency shutdown request to the control device if the output signals of the modules match a predetermined second signal pattern.

16. The method of claim 2, further comprising including output signals of at least one member of group comprising a magnetic field sensor and a microphone module in the comparison to the predetermined second signal patterns.

17. The method of claim 1, further comprising transmitting an alive signal from the evaluation device to the control device at cyclic intervals.

18. The method of claim 1, further comprising including output signals of at least one brightness sensor in the comparison to predetermined first signal patterns.

19. The method of claim 1, further comprising comparing the output signals of an acceleration sensor to vibration and/or acceleration limit values.

20. A handheld unit for an industrial technical system having multiple activatable components, comprising:
a user input device;
multiple modules selected from a group including a proximity sensor, an acceleration sensor, an orientation sensor, a position-determining device and an image-capturing device,
an evaluation device to which commands are input by the user input device and to which output signals are fed by selected modules, said evaluation device comparing output signals of the modules to predetermined first signal patterns and transmitting control commands that effect an activation of at least one component of the industrial technical system to a control device of the industrial technical system only if a command requesting the activation of said component is input by said user input and the output signals of the modules match a predetermined first signal pattern.

21. The handheld unit of claim 20, further comprising predetermined second signal patterns, said evaluation device being configured to compare the output signals of the modules to the predetermined second signal patterns and transmit an emergency shutdown request to the control device if the output signals of the modules match one of the predetermined second signal patterns.

22. The handheld unit of claim 20, further comprising a signal output by at least one member of a group comprising a magnetic field sensor and a microphone module, the evaluation device being configured to compare said output signal to the predetermined second signal patterns.

23. The handheld unit of claim 20, wherein the evaluation device is configured to transmit an alive signal to the control device at cyclic intervals.

24. The handheld unit of claim 20, further comprising a brightness sensor having an output signal, the evaluation device being configured to compare the output signals of modules, including the signal output by the brightness sensor, to the predetermined first signal patterns.

25. The handheld unit of claim 20, further comprising an acceleration sensor having an output signal, the evaluation device being configured to compare the output signal of the acceleration sensor, to vibration and/or acceleration limit values.

26. The handheld unit as claimed in claim 20, wherein the handheld unit is a communication technology device.
